(19) United States
(12) Patent Application Publication
(10) Pub. No.: US 2013/0106361 A1
(43) Pub. Date: May 2, 2013

(54) Device and method for warming up a battery

(71) Applicant: Hilti Aktiengesellschaft, Schaan (LI)

(72) Inventor: Walter WISSMACH, Muenchen (DE)

(73) Assignee: Hilti Aktiengesellschaft, Schaan (LI)

(21) Appl. No.: 13/666,371

(22) Filed: Nov. 1, 2012

(30) Foreign Application Priority Data
Nov. 2, 2011 (DE) DE 102011085631.5

(51) Int. Cl. H02J 7/00

(52) U.S. Cl. 320/135

(57) ABSTRACT

A device according for warming up cells of a battery having at least one cell including a capacitor. The capacitor is connected to the inductor of the at least one battery cell and its connecting elements to form a resonant circuit in such a way that its thermal loss serves to warm up the at least one battery cell.

This claims the benefit of German Patent Application DE 10 2011 085 631.5, filed Nov. 2, 2011 and hereby incorporated by reference herein.

### BACKGROUND

The present invention relates to a device and to a method for warming up a battery. In particular, the invention relates to a device and to a method for warming up the cells of a battery. The battery can be used, for example, in a handheld power tool, which is especially an electric handheld power tool such as, for instance, an electric screwdriver.

Batteries, which can also be secondary batteries or rechargeable batteries, display worse battery properties at temperatures below normal room temperature. In particular, the batteries have a reduced capacity to draw or charge higher electric currents at such temperatures. As a consequence, the use of battery-powered devices is greatly restricted in actual practice. This is a major drawback, especially for electric handheld power tools.

In order to overcome this drawback, electric heating elements are normally integrated into the battery and they can be switched on as needed. This allows the battery cells to be warmed up to such an extent that the battery can be operated normally, in other words, it can be charged or discharged during use. Here, the heating elements are supplied with electric power either by the battery itself or else via an external device, for instance, a charger. Such a solution, however, has the disadvantage that, on the one hand, additional heating elements have to be installed. On the other hand, the heating elements need a considerable amount of energy in order to warm up the battery cells. If the heating elements are supplied with power by the battery itself, this considerably reduces the output that is ultimately available for the device that is to be supplied with power from the battery. If, in order to avoid this drawback, the heating elements are supplied with energy by the external device, for instance, the charger, then, as a rule, this greatly diminishes the portability of the actual device that is actually to be powered by the battery. In the case of an electric handheld power tool, permanent supply by means of an external device is generally not possible.

Moreover, with very cold batteries, that is to say, batteries with a temperature of about −10° C., the following scenarios might occur.

In a first scenario, in spite of the cold, it might still be possible to draw sufficient output from the battery in order to operate, for example, an electric device. The drawback here, however, is that this might damage the battery, thus markedly reducing its service life.

In a second scenario, the battery, even if it is fully charged, might no longer yield sufficient output in order to operate, for example, the electric device. Consequently, this has the disadvantage that, despite a fully charged battery, it is not possible to operate the electric device.

### SUMMARY OF THE INVENTION

It is an object of the present invention to provide a device for warming up a battery having at least one cell comprises a capacitor which is connected to the inductor of the at least one battery cell and its connecting elements so as to form a resonant circuit in such a way that its thermal loss serves to warm up the at least one battery cell.

It is an object of the present invention to provide a resonant circuit that is damped practically only by the internal resistance of the battery cells and, in the case of at least two battery cells, by their connecting elements. The connecting elements can also be referred to as battery cell connectors. The internal resistance is made up of the ohmic resistance and the inductance of the battery cells and, in the case of at least two battery cells, by their connecting elements. The thermal loss generated during the damping serves almost exclusively to warm up the battery. For this reason, the device according to the invention operates very efficiently.

Moreover, an alternating current can flow at a suitable frequency in the battery, or to put it more precisely, in its cells. As a result, the charge (current-time area) per half-wave drawn from and fed back into the battery becomes smaller, which leads to less stress on the internal battery cell elements such as the electrodes, electrolyte and separators.

Furthermore, very little effort is needed to install the capacitor. Moreover, the capacitor and thus the device according to the invention only require a very small amount of space, so that either one of them can be accommodated in the battery itself, in a charger or in a device that is to be operated with the battery. In the case of an electric device having a motor, it is also possible to make use of the capacitor that is already present.

Another advantage is that the device according to the invention can also be operated while the battery is being charged or discharged. This reduces or eliminates the waiting time before the battery is operational at temperatures that are below the normal room temperature.

In one embodiment, the device has an oscillator control unit that is configured to excite the resonant circuit with a frequency that can be adjusted within a pre-specified range.

The battery cells can be connected in series and the capacitor can be connected in parallel to the series circuit that is formed in the process.

In one embodiment, a switch controlled by the oscillator control unit is connected in series to the capacitor and the series circuit that is formed in the process is connected in parallel to the series circuit of the battery cells.

In this embodiment, the device according to the invention can be employed irrespective of whether an ohmic-inductive consumer having a corresponding semiconductor circuit is present or not.

The oscillator control unit and the switch it controls are likewise small in size, so that the amount of space needed by the device is still so small that it can be simply accommodated either in the battery itself or in the charger or in the device that is to be operated with the battery.

In one embodiment, the switch is a semiconductor, especially a field-effect transistor.

Moreover, the switch can be connected to a recovery diode and/or to at least two actuation stages.

In another embodiment, the oscillator control unit is configured to control a transformer. In this case, there is no switch that is directly installed in the resonant circuit.

In one embodiment, the device has a current meter for measuring the electric current flowing in the resonant circuit, whereby the oscillator control unit is configured so that—as a function of the current measured with the current meter—it can control the heat output generated by the device. The control of the heat output generated with the device can be carried out as a function of the current measured with the current meter, either as an alternative to or in addition to the control of the frequency of the resonant circuit.

Moreover, a battery to supply an electric device with electric energy is being put forward here. The battery has at least one cell and a device according to the invention of the type described above for warming up the at least one battery cell.

The electric device is, for example, a handheld power tool or a charger for charging a battery, which can be used to operate the handheld power tool.

The battery can have a cell-monitoring means for monitoring the at least one battery cell, whereby the oscillation control unit is integrated into the cell-monitoring means.

Furthermore, a charger is being put forward here for charging a battery that has at least one cell. The charger has a device according to the invention of the type described above for warming up the battery.

Moreover, a handheld power tool is being put forward here which has a device according to the invention of the type described above for warming up the battery.

In particular, the handheld power tool is an electric handheld power tool such as, for instance, an electric screwdriver.

The electric screwdriver has a housing with a handle with which a user can hold and guide the electric screwdriver. A pushbutton on the handle allows the user to start operation of the electric screwdriver. For instance, the user has to continuously hold the pushbutton in the depressed position in order to keep the electric screwdriver in operation.

The electric screwdriver has a tool socket into which the user can insert a screw bit. When the pushbutton is actuated, an electric motor rotates the tool socket around its axis. The electric motor is coupled to the tool socket via a spindle and, if applicable, via additional components of a drive train, for instance, a clutch, gears.

Even at low temperatures, a handheld power tool with the device according to the invention is independent of the availability of external equipment such as an electric power source, a charger, etc. Moreover, the handheld power tool with the device according to the invention is also independent of special configurations such as the use of the battery in the handheld power tool or the external charger. Consequently, users acquire a great deal more of mobility, even at low temperatures, which makes the handheld power tool more convenient to use and/or more portable.

Furthermore, a method for warming up a battery having at least one cell is being put forward here. In one method step, a resonant circuit to which a capacitor and the inductor of the at least one battery cell and its connecting elements are connected is excited, so that the thermal loss of the resonant circuit serves to warm up the at least one battery cell.

### BRIEF DESCRIPTION OF THE DRAWINGS

The description below explains the invention on the basis of exemplary embodiments and the figures. The figures show the following:

FIG. 1: a circuit diagram of a first embodiment of a device for warming up a battery;

FIG. 2: a schematic flowchart of a method for warming up a battery according to the first embodiment;

FIG. 3: a schematic block diagram of an electric device according to the first embodiment;

FIG. 4: a circuit diagram of a second embodiment of a device for warming up a battery;

FIG. 5: a circuit diagram of a third embodiment of a device for warming up a battery.

Unless otherwise indicated, identical or functionally identical elements are designated in the figures with the same reference numerals.

### DETAILED DESCRIPTION

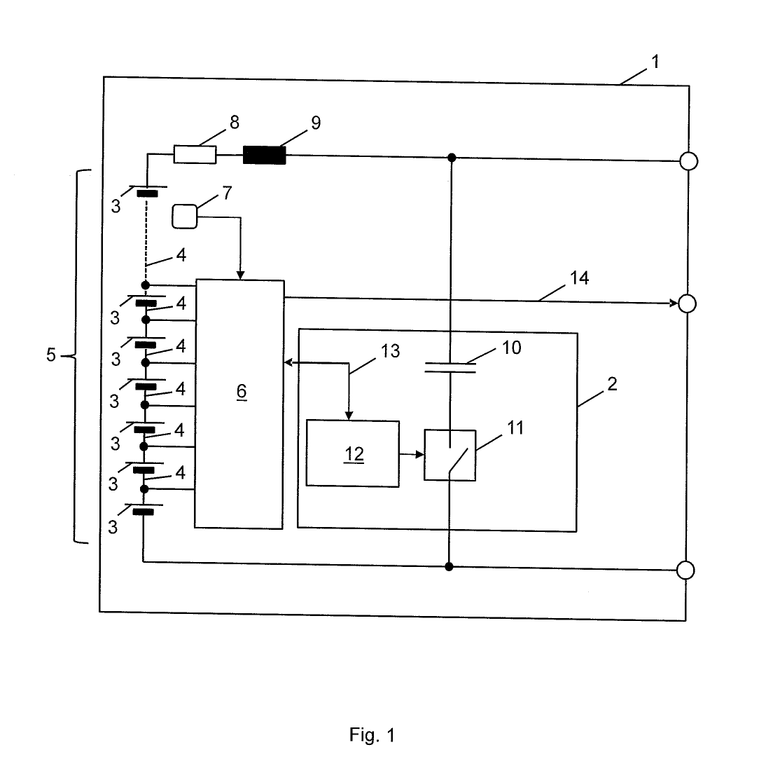

FIG. 1 shows a circuit diagram of a battery 1 which is connected to a device 2 according to a first embodiment. The battery 1 can also be referred to as a secondary battery or rechargeable battery.

The battery 1 has a plurality of battery cells 3 connected in series. For this purpose, the battery cells 3 are connected to connecting elements 4, that is to say, connecting lines and/or connectors, and they form a series circuit 5. The battery cells 3 are monitored with a cell-monitoring means or cell monitor 6 of the battery 1, for example, in terms of its temperature, which is measured by a temperature sensor 7 and transmitted to the cell-monitoring means 6. The series circuit 5 formed by the battery cells 3 has an internal resistor 8 and an inductor 9. The internal resistor 8 is the ohmic resistor of the battery cells 3 and of its connecting elements 4. The inductor 9 is the inductor of the battery cells 3 and their connecting elements 4.

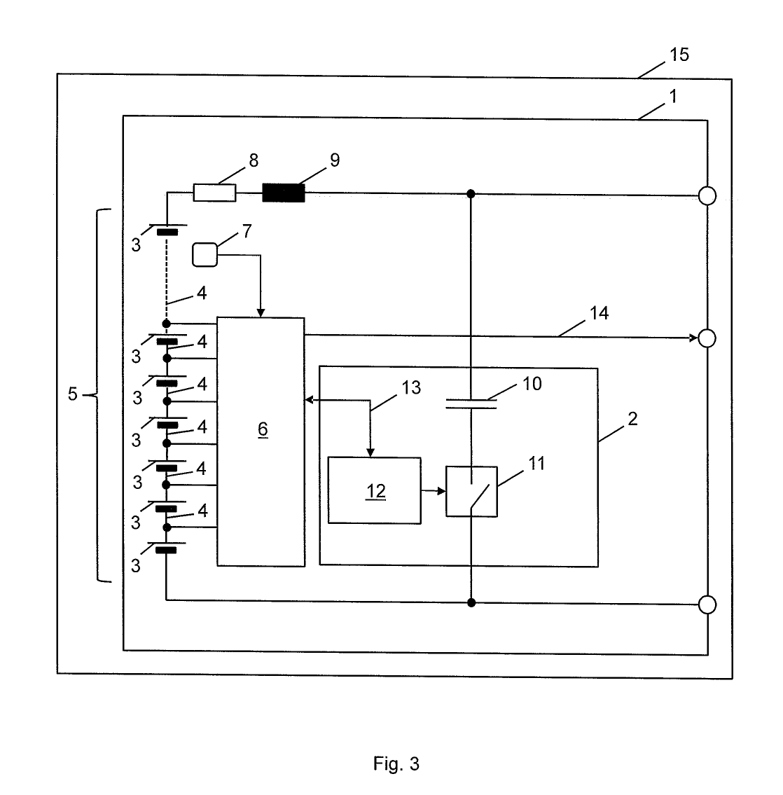

The device 2 has a capacitor 10, a switch 11, especially a semiconductor switch, and an oscillator control unit 12. The oscillator control unit 12 communicates with the cell-monitoring means 6 via a communication connection 13. In addition, the cell-monitoring means 6 can communicate via a communication connection 14 with an external device 15 that is schematically depicted in FIG. 3.

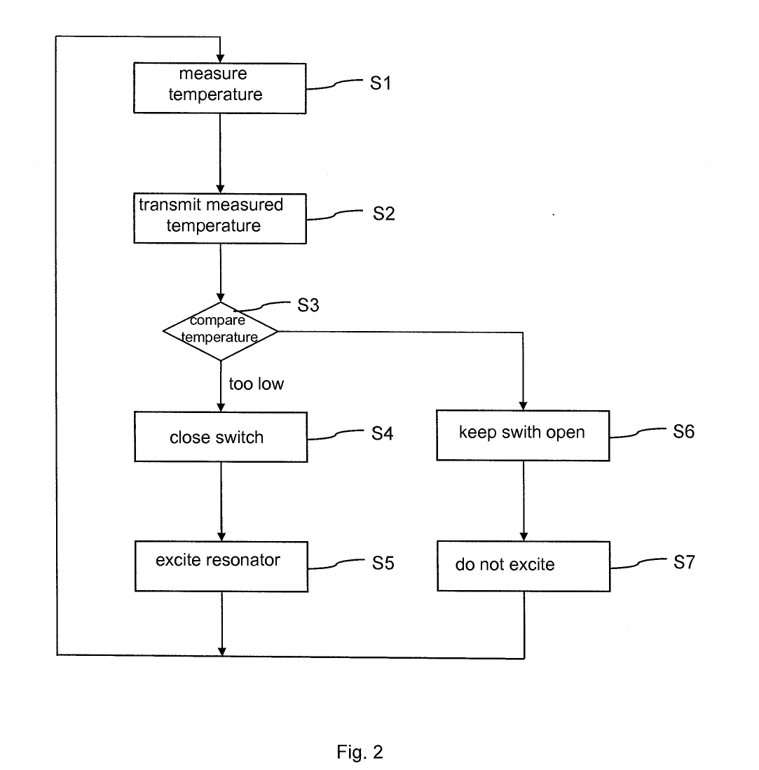

In FIG. 1, the capacitor 10 is connected to the inductor 9 of the battery 1 to form a resonant circuit. In particular, the capacitor 10 and the inductor 9 form a parallel resonant circuit. The switch 11 is connected in series to the capacitor 10. The oscillator control unit 12 controls the switch 11 in order to control the oscillation of the resonant circuit made up of the capacitor 10 and the inductor 9. The oscillator control unit 12 controls the resonant circuit 9, 10 in such a way that it is in resonance. Towards this end, the capacitor 10 is appropriately adapted to the inductor 9, that is to say, it is a resonant capacitor. The oscillator control unit 12, however, is configured to excite, especially to control, the resonant circuit within a certain range around the resonance frequency fR of the resonant circuit made up of the capacitor 10 and the inductor 9. This certain range around the resonance frequency fR is also referred to as the pre-specified range within which the frequency of the resonant circuit made up of the capacitor 10 and the inductor 9 can be set. Setting the frequency of the resonant circuit makes it possible to control the heat output generated by the device 2, as has been described especially in conjunction with FIG. 2.

FIG. 2 shows a method for warming up the battery 1 in order to supply electric power to the electric device 15. In particular, this is a method for warming up the cells 3 of battery 1.

In step S1, the temperature sensor 7 measures the temperature of the plurality of battery cells 3 and/or the ambient temperature around the battery 1 and/or its battery cells 3. For this purpose, the temperature sensor 7 especially comprises a plurality of individual measuring cells in order to detect the above-mentioned temperature(s).

In step S2, the cell-monitoring means 6 transmits the temperature(s) measured by the temperature sensor 7 to the oscillator control unit 12 by means of the communication connection 13.

In step S3, the oscillator control unit 12 compares the temperature measured with the temperature sensor 7 to the room temperature, which is considered to be approximately 20° C. In particular, it is ascertained in step S3 whether or not the battery cells 3 are too cold to allow satisfactory operation of an electric device 15 with the battery 1.

If the temperature of the battery 1 and/or its battery cells 3 is too low and/or if the ambient temperature around the battery 1 is lower than the room temperature, the flow proceeds to step S4 in which the oscillator control unit 12 turns the switch 11 to the closed position. As a result, in step S5, the oscillator control unit 12 can excite the resonant circuit, especially in the pre-specified range around the resonance frequency. The thermal loss of the resonant circuit made up of the capacitor 10 and the inductor 9 generated in this process then serves to warm up the battery cells 3.

If, in contrast, the comparison in step S3 shows that the temperature of the battery 1 and/or its battery cells 3 is not too low and/or if the ambient temperature around the battery 1 and/or its battery cells 3 is about the same as the room temperature, in step S6, the oscillator control unit 12 turns the switch 11 to the open position or keeps it there, as shown in FIG. 1. As a result, in step S7, the oscillator control unit 12 cannot excite the resonant circuit. Consequently, no thermal loss is caused by the resonant circuit made up of the capacitor 10 and the inductor 9, so that the battery cells 3 cannot be warmed up in this manner.

Subsequent to step S5 and step S7, the flow goes back to step S1.

In summary, on the basis of the temperature(s) detected by the temperature sensor 7, the oscillator control unit 12 can control the resonant circuit made up of the capacitor 10 and the inductor 9. In other words, the control is carried out as a function of the temperature(s) detected by the temperature sensor 7.

FIG. 3 shows a schematic block diagram of an embodiment of the electric device 15. The electric device 15 has the battery 1 with the device 2 according to FIG. 1. The electric device 15 is, for instance, a handheld power tool. The electric device 15 can also be, for example, a charger for charging the battery 1, into which the device 2 has been installed. The device 15 and the cell-monitoring means 6 communicate with each other via the communication connection 14. The device 2 is especially built into the battery 1. The device 2 can also be built into the charger 15.

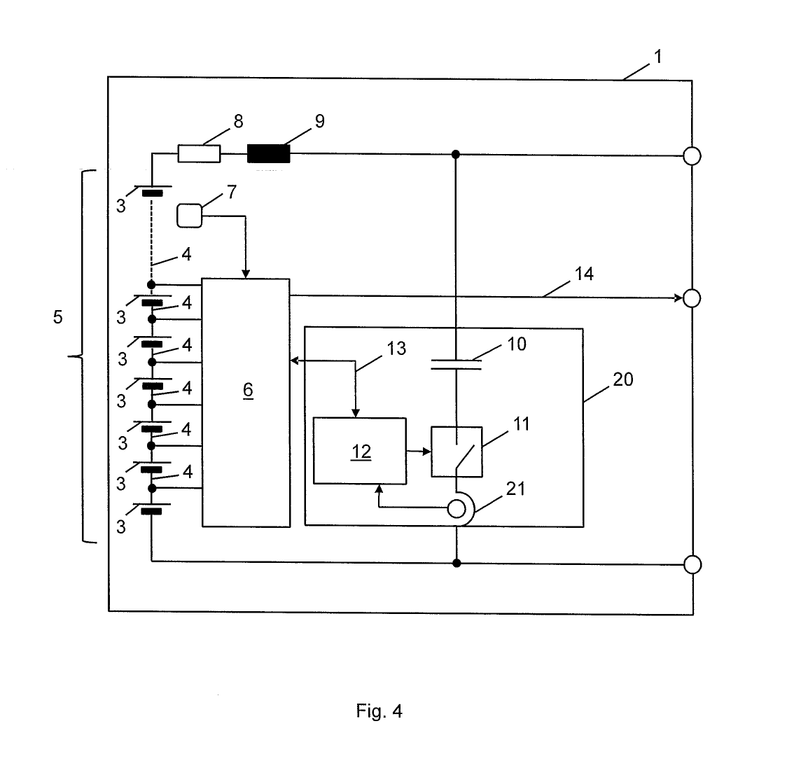

FIG. 4 shows a circuit diagram of a battery 1 to which a device 20 according to a second embodiment is connected. The device 20 is largely structured in the same manner as the device 2 of the first embodiment. Moreover, it has the same mode of operation, so that in this context, reference is hereby made to the description of the first embodiment.

However, the device 20 additionally has a current meter 21 that serves to measure the electric current flowing in the resonant circuit made up of the capacitor 10 and the inductor 9. The oscillator control unit 12 is configured in such a way that it controls or regulates the electric current flowing in the resonant circuit 9, 10.

The control carried out by the oscillator control unit 12 functions analogously to the control described in FIG. 2. In other words, in step S6, the oscillator control unit 12 controls or regulates the current flowing in the resonant circuit 9, 10 rather than the frequency fR. All of the other steps S1 to S5 and step S7 in this embodiment are the same as steps S1 to S7 and step S7 of the first embodiment.

Setting the electric current of the resonant circuit and/or the amplitude of the electric current of the resonant circuit makes it possible to control or regulate the heat output generated by the device 20. The other parts of the battery 1 are the same as the parts described for the first embodiment, so that in this context, reference is hereby also made to the description of the first embodiment.

Analogously to FIG. 3, the battery 1 with the device 20 can also be arranged in the electric device 15. In this case as well, the electric device 15 is, for example, a handheld power tool. The electric device 15, however, can also be, for instance, a charger for charging the battery 1.

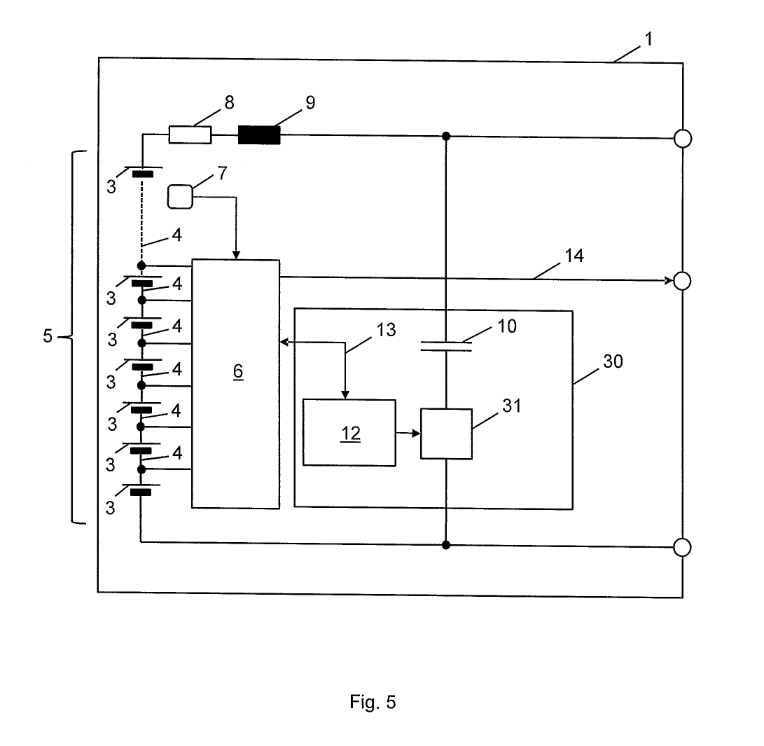

FIG. 5 shows a circuit diagram of a battery 1 to which a device 30 according to a third embodiment is connected. The device 30 is likewise structured largely in the same manner as the device 2 of the first embodiment, and it has the same mode of operation, so that, in this context, reference is hereby made to the description of the first embodiment. However, instead of the switch 11 built directly into the resonant circuit in device 2, the device 30 has a transformer 31 for structuring an active oscillator. The heat output generated by the device 30 can be controlled by means of such a circuit as well. The other parts of the battery 1 are the same as the parts described for the first embodiment, so that in this context, reference is also hereby made to the description of the first embodiment.

Analogously to FIG. 3, the battery 1 with the device 30 shown in FIG. 5 can also be present in the electric device 15. In this case as well, the electric device 15 is, for instance, a handheld power tool. However, the electric device 15 can also be, for example, a charger for charging the battery 1.

What is claimed is:

1. A device for warming up a battery having at least one cell and connecting elements, the at least one cell and related connecting elements having an inductor, the device comprising:
a capacitor connected to the inductor of the at least one battery cell and the connecting elements to define a resonant circuit having thermal loss serving to warm up the at least one cell.

2. The device as recited in claim 1 further comprising an oscillator control unit configured to excite the resonant circuit with a frequency adjustable within a pre-specified range.

3. The device as recited in claim 1 wherein the at least one cell includes a plurality of cells of the battery connected in series to define a series circuit, the capacitor being connected in parallel to the series circuit.

4. The device as recited in claim 3 further comprising an oscillator control unit and a switch controlled by the oscillator control unit is connected in series to the capacitor to define a second series circuit, the second series circuit and the series circuit being connected in parallel.

5. The device as recited in claim 4 wherein the switch is a semiconductor switch.

6. The device as recited in claim 4 wherein the switch is connected to a recovery diode and/or to at least two actuation stages.

7. The device as recited in claim 2 wherein the oscillator control unit is configured to control a transformer.

8. The device as recited in claim 1 further comprising a current meter for measuring the electric current flowing in the resonant circuit, and further comprising an oscillator control unit configured so that, as a function of the current measured with the current meter, the oscillator control unit can control the heat output generated by the device.

9. A battery to supply an electric device with electric energy, the battery comprising:
at least one battery cell; and
the device as recited in claim 1 for warming up the at least one battery cell.

10. The battery as recited in claim 9 further comprising a cell monitor for monitoring the at least one battery cell, and further comprising an oscillation control unit integrated into the cell monitor.

11. A charger for charging a battery having at least one cell, the charger comprising:
a device for warming up the battery as recited in claim 1.

12. A handheld power tool comprising:
the device for warming up the battery as recited in claim 1.

13. A handheld power tool comprising:
the battery as recited in claim 9.
